(19) United States
(12) Patent Application Publication
(10) Pub. No.: US 2024/0361883 A1
(43) Pub. Date: Oct. 31, 2024

(54) Automatic Link Collecting And Displaying Systems

(71) Applicant: Capital One Services, LLC, McLean, VA (US)

(72) Inventor: Bryan Tamayo, Allen, TX (US)

(21) Appl. No.: 18/141,193

(22) Filed: Apr. 28, 2023

(51) Int. Cl. G06F 3/0483; G06F 3/0482; G06F 3/0485; G06F 40/134

(52) U.S. Cl. CPC G06F 3/0483; G06F 3/0482; G06F 3/0485; G06F 40/134

(57) ABSTRACT

Aspects described herein may allow collecting and displaying links to webpages. A computing device may cause display of digital content that comprises a plurality of links each directed to a respective webpage. A first portion, of the digital content, may be displayed in a viewport of a user interface. The first computing device may determine that a first link, of the plurality of links, is displayed in the viewport, wherein the first link is directed to a first webpage. The first computing device may generate, based on determining that the first link is displayed in the viewport, a preview of the first webpage. The first computing device may cause, in a first area of the user interface, display of the first link and the preview of the first webpage. In this way, the display of the links may be more effective.

### FIELD OF USE

Aspects of the disclosure relate generally to data processing. More specifically, aspects of the disclosure may provide for systems and methods for collecting and displaying links to digital content.

### BACKGROUND

A web browser may display an article on a webpage. The author of the article may embed, in the webpage, a plurality of links directed to other webpages that provide information relevant to the article. The plurality of links may be dispersed throughout the original webpage. A user who is interested in a link located at the beginning of the article may encounter difficulties. If the user follows the link to another webpage before completing the article, the user may forget what the user has read about in the article after viewing the linked webpage. Alternatively, if the user finishes the article before accessing the linked webpage, the user may have difficulties finding the link. For example, if the user's electronic device has a small interface and/or the article is long, the link may no longer be displayed in the user interface when the article reaches the end. To find the link, the user may need to scroll back to the previously displayed portion of the article, which may be time-consuming and/or lead to a diminished user experience.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Users may view digital content (e.g., text, images, videos, or other types of multimedia) on a user device. The digital content may not be fully displayed within the user interface at a given time. For example, if the digital content comprises an article, the user interface may display only a portion of the article at a time. The user may scroll multiple times to view the entire article. In another example, if the digital content comprises a video, the entire video may be played over a time duration. Only one frame in the video may be displayed at a given time point. A plurality of links may be embedded (e.g., by the author of the digital content) in the digital content. Each of the links may be directed to another digital content (e.g., another webpage) that provides information relevant to the original digital content. The links may be located at different places in the original digital content, and at any given time point, some of the links may not be visible. A user interested in a particular link may have difficulties finding the link, if the user views other portions of the digital content before accessing the link, as the link may no longer be displayed on the user interface. Finding the link in a portion of the digital content that is no longer displayed may be difficult and/or time-consuming, which may diminish the user experience towards the user interface.

To overcome limitations in the prior art described above, and to overcome other limitations that will be apparent upon reading and understanding the present specification, aspects described herein are directed towards collecting and displaying links to digital content. As described herein, a user device may collect links that are located in a portion of digital content that a user has viewed, and/or display the links in an area of the user interface. The collected links may be continuing displayed even if the portion of the digital content that comprises the links is no longer displayed. As the user views a larger portion of the digital content, more links may be collected and displayed in that area. In this way, the user may easily access links that the user has previously viewed, even if the user interface is not able to display the entire digital content at once. The display efficiency of the user interface may be improved.

In at least some embodiments, a first computing device may receive, a request to display, on a user interface associated with the first computing device, digital content. The digital content may comprise a plurality of links each directed to a respective webpage. The first computing device may receive, from a second computing device, the digital content and may cause, on the user interface, display of a first portion, of the digital content, in a viewport of the user interface. The first computing device may determine that a first link, of the plurality of links, is displayed in the viewport, wherein the first link is directed to a first webpage. The first computing device may generate, based on determining that the first link is displayed in the viewport, a preview of the first webpage. The first computing device may cause, in a first area of the user interface, display of the first link and the preview of the first webpage.

The first computing device may further cause, in the viewport and based on an input instruction, display of a second portion of the digital content, wherein the second portion of the digital content comprises a second link, of the plurality of links, that is directed to a second webpage, and wherein the second portion of the digital content does not comprise the first link.

The first computing device may generate a preview of the second webpage and cause, in a second area of the user interface, display of: the first link, the preview of the first webpage, the second link, and the preview of the second webpage. The input instruction may comprise a mouse being scrolled in a direction.

The first computing device may further divide the user interface into at least two areas. The first computing device may generate the preview of the first link further based on the first link is displayed in a third area, of the at least two areas, that comprises a central point of the user interface.

The first computing device may generate the preview of the first webpage further based on determining that the first link is displayed in the viewport for a time period exceeding a threshold.

The first computing device may generate the preview of the first webpage by receiving, based on the first link, the first webpage; and extracting, from the first webpage, information associated with content of the first webpage.

The first webpage comprises an article, and wherein the preview of the first webpage comprises at least one of: a title of the article or a summary of the article.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein:

FIG. 2 depicts an example computing environment in accordance with one or more illustrative aspects discussed herein:

FIG. 3 is a flow diagram of an example method for link collecting and displaying in accordance with one or more illustrative aspects discussed herein:

FIG. 4A shows an illustrative user interface in accordance with one or more illustrative aspects discussed herein:

FIG. 4B shows an illustrative user interface in accordance with one or more illustrative aspects discussed herein:

FIG. 4C shows an illustrative user interface in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

To facilitate accessing linked digital content at a later time point after the user finishes viewing a portion of a digital content comprising the link, aspects discussed herein may provide a computer-implemented method directed toward collecting and displaying links to digital content. A user device may collect links that are located in a portion of digital content that a user has viewed, and/or display the links in an area of the user interface. The collected links may be continuing displayed even if the portion of the digital content that comprises the links is no longer displayed. As the user views a larger portion of the digital content, more links may be collected and displayed in that area. In this way, the user may access links that the user has previously viewed easily even if the user interface is not enough to display the entire digital content at once. Aspects discussed herein may improve the functioning of computers and/or a display device at least because the links displayed via the display device may be accessed easier at a time point chosen by the user. Display efficiency may be improved and/or user experience towards the display device may be improved.

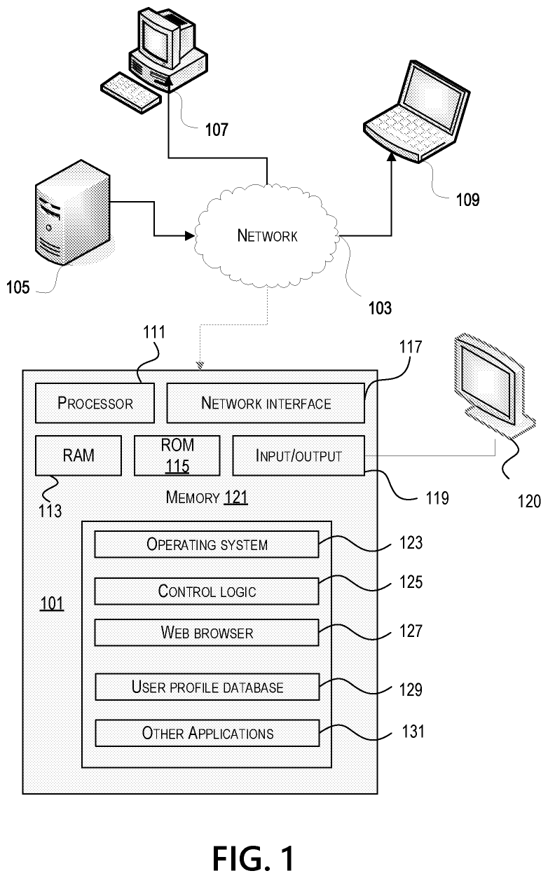

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading or executing instructions and performing one or more actions based on the instructions. In some embodiments, computing device 101 may represent, be incorporated in, or include various devices such as a desktop computer, a computer server, a mobile device (e.g., a laptop computer, a tablet computer, a smartphone, any other type of mobile computing devices, and the like), or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., key board, mouse, display, printer, etc.), and memory 121. Processor 111 may include one or more computer processing units (CPUs), graphical processing units (GPUs), or other processing units such as a processor adapted to perform computations associating converting information, routing copies of messages, or other functions described herein. I/O 119 may include a variety of interface units and drives for reading, writing, displaying, or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling the overall operation of the computing device 101, control logic 125 for instructing computing device 101 to perform aspects discussed herein. Furthermore, memory 121 may store various databases and applications depending on the particular use, for example, web browser 127, user profile database 129, and other applications 131 may be stored in a memory of a computing device used at a server system that will be described further below. Control logic 125 may be incorporated in or may comprise a linking engine that updates, receives, or associates various information stored in the memory 121. In other embodiments, computing device 101 may include two or more of any or all of these components (e.g., two or more processors, two or more memories, etc.) or other components or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, devices 101, 105, 107, 109, and others may operate in concert to provide parallel computing features in support of the operation of control logic 125.

One or more aspects discussed herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer-readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like. Particular data structures may be used to more effectively implement one or more aspects discussed herein, and such data structures are contemplated within the scope of computer-executable instructions and computer-usable data described herein. Various aspects discussed herein may be embodied as a method, a computing device, a data processing system, or a computer program product.

The data transferred to and from various computing devices may include secure and sensitive data, such as confidential documents, customer personally identifiable information, and account data. Therefore, it may be desirable to protect transmissions of such data using secure network protocols and encryption, or to protect the integrity of the data when stored on the various computing devices. A file-based integration scheme or a service-based integration scheme may be utilized for transmitting data between the various computing devices. Data may be transmitted using various network communication protocols. Secure data transmission protocols or encryption may be used in file transfers to protect the integrity of the data such as, but not limited to, File Transfer Protocol (FTP), Secure File Transfer Protocol (SFTP), or Pretty Good Privacy (PGP) encryption. In many embodiments, one or more web services may be implemented within the various computing devices. Web services may be accessed by authorized external devices and customers to support input, extraction, and manipulation of data between the various computing devices. Web services built to support a personalized display system may be cross-domain or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, or firewalls. Such specialized hardware may be installed and configured in front of one or more computing devices such that any external devices may communicate directly with the specialized hardware.

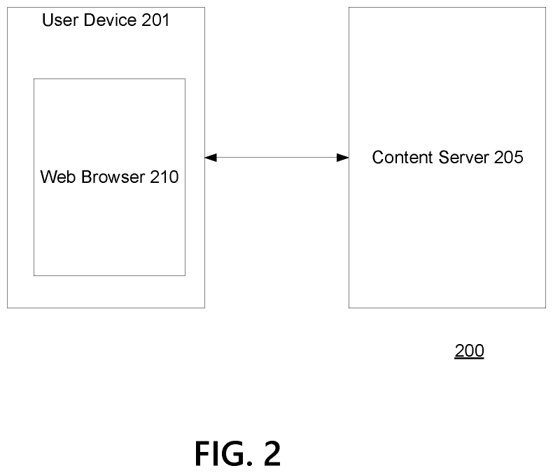

FIG. 2 depicts an illustrative computing environment for collecting and displaying links to digital content in accordance with one or more example embodiments. Referring to FIG. 2, the computing environment 200 may include a user device 201 and a content server 205. The user device 201 may be an electronic device associated with a user. The user device 201 may be capable of receiving data from other devices, transmitting data to other devices, processing data and/or causing data to be displayed in a user interface associated with the user device 201. For example, the user device 201 may comprise one or more of smartphones, tablets, laptops, desktop computers, wearable devices, smartwatches, augmented or virtual reality devices, and Internet of Things (IoT) devices. The content server 205 may be configured to store, process, manage and/or deliver digital content (e.g., text, images, audio, video or other multimedia formats). The content server may be deployed, for example, as a stand-alone system, in a distributed network architecture or a cloud-based architecture. Each of the user device 201 and the content server 205 may be a computing device 101 as described in FIG. 1. The user device 201 may be communicatively connected with the content server 205 via network 103 as described in FIG. 1.

The user device 201 may comprise a software application that is configured to receive, process, and/or display digital content. For example, the software application may be a web browser 210, an e-book reader, a social media client, a news reader, a multimedia player, or any other applications configured to deliver the digital content. For convenience, the description below may use web browser 210 as an example, but it is appreciated that other software applications are possible.

The user device 201 may request digital content from the content server 205. The user device 201 may display the digital content via the web browser 210. The digital content may comprise a plurality of links. Each of the plurality of links may be directed to another digital content. For example, each link may comprise an address (e.g., a uniform resource locator (URL)) of online digital content. The digital content may be delivered and/or displayed in a webpage format, for example, if the software application is a web browser 210. For convenience, the description below may use a webpage as an example of digital content, but it is appreciated that other digital content formats are possible.

A webpage directed by a link may comprise content that is related to the original digital content. For example, the digital content displayed on the user device 201 may be an article. A link may be embedded at the end of a sentence in the article. The link may be directed to a webpage associated with the content of the sentence. The webpage may be an information source for the sentence. For example, the article may state a big ceremony was held in a national park. The link may be directed to a webpage associated with an official announcement of the ceremony. The webpage may provide supplemental information to the original digital content. For example, the article may state the government will increase investment in a particular industry. The webpage may comprise other experts opinions on the future of that industry. The webpage may comprise advertisements or promotions related to the digital content. For example, the article may state a new product is popular. The webpage may be an online shopping page selling the new product. It is appreciated that the information in the linked webpages and/or the relation between the original digital content and the linked webpage are merely examples. The linked webpage may comprise any other types of information, either related or unrelated to the original digital content.

The plurality of links may be dispersed throughout the digital content. For example, the links may be dispersed at the beginning, in the middle, and/or at the end of the digital content. A link may be embedded at a place that is relevant to the content of the linked webpage. For example, in an article on product reviews, a link to an online shopping page may be displayed at a place, in the article, where the corresponding product is introduced.

A user viewing the original digital content may encounter difficulties accessing the links. If the user follows the link to another webpage before completing the article, the user may forget what the user has read about the article after viewing the linked webpage. The viewing of the original digital content may be disrupted. For example, if the user, while reading an article on product reviews, accesses a linked online shopping webpage that sells a first product, the user may forget to read the rest of the product review. The user may purchase the first product without knowing the rest of the product review introduces other products that are more suitable for the user. Alternatively, the user may go back and forth between the product review and the online shopping pages, which diminishes the experience of reading the product review:

Additionally or alternatively, if the user finishes reading the original digital content before accessing any of the links, the user may have difficulties in finding a particular link, for example, if the link is located at the beginning of the digital content. For example, if the user's electronic device has a small interface and/or the article is long, the link may no longer be displayed in the user interface when the article reaches the end. To find the link, the user may need to scroll back to the previously displayed portion of the article. Things may go worse if the digital content comprises a video and the links are embedded in the video, as the user may need to trick-play the video to find the link. This may be time-consuming and diminish user experience.

As described herein, the user device 201 may collect the links embedded in the portion of the digital content that the user has viewed, and/or display the links in an area that is separate from the display of the original digital content. This may allow the user to finish the digital content and easily access the links at another time chosen by the user.

A browser extension may operate in conjunction with the web browser 210. The browser extension may be a software model that is implemented using one or more programming languages, such as JavaScript, hypertext markup language (HTML), or cascading style sheets (CSS). The browser extension may communicate with the web browser 210 via one or more application programming interfaces (APIs). The browser extension may communicate with the web browser 210 through one or more API calls. The browser extension may be configured to collect the links and/or display the links as described herein. This may allow the link collection and display to be implemented in an existing web browser 210.

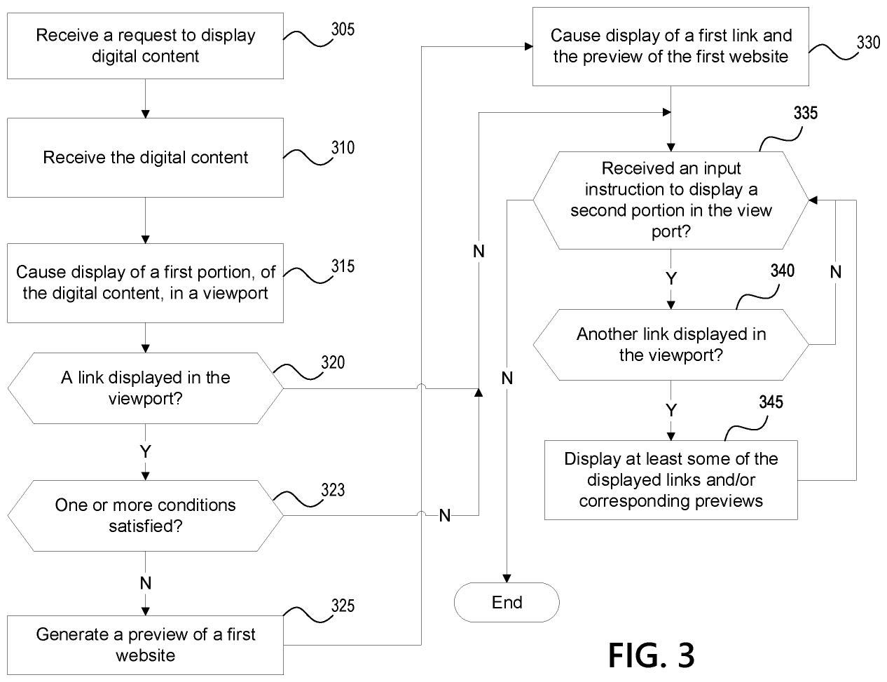

FIG. 3 is a flow diagram depicting a method 300 for collecting and displaying links to digital content in accordance with one or more illustrative aspects discussed herein. The steps in method 300 may be performed by a system comprising, for example, content server 205 and user device 201 as may be shown in FIG. 2.

At step 305, a first computing device (e.g., the user device 201 shown in FIG. 2) may receive a request to display digital content. The user device 201 may receive (e.g., via a web browser 210), from a user input request, an address (e.g., an URL) of a webpage. The digital content may be displayed on a user interface associated with the first computing device.

The digital content may comprise a plurality of links. The plurality of links may be dispersed throughout the digital content. For example, the links may be dispersed at the beginning, in the middle, and/or at the end of the digital content. For example, the digital content may comprise an article. Different links may be located next to different sentences in the article. In another example, the digital content may comprise a video. Different links may be displayed when different frames are played.

Each of the plurality of links may be directed to a respective webpage. As described in connection with FIG. 2, the linked webpage may comprise content that is related to the original digital content. A link may be embedded at a place that is relevant to the content of the linked webpage.

At step 310, the first computing device may receive, from a second computing device (e.g., the content server 205 shown in FIG. 2), the digital content. The first computing device may, based on the address of the webpage, send a request to a content server 205 that hosts the webpage. The content server 205 may send the webpage to the first computing device.

At step 315, the first computing device may cause, on the user interface, display of a first portion of the digital content. The first portion of the digital content may be displayed in a viewport of the user interface. The viewport may be a dialog window of a software application that is configured to display the digital content. The software application may be described in connection with FIG. 2. For example, the viewport may be a dialog window of a web browser. The viewport may occupy the entire user interface or may occupy only a portion of the user interface. The viewport may not be able to fully display the digital content at a given time. For example, if the digital content comprises a long article, the viewport may display the beginning ten percent of the article, for example, due to the size of the viewport. In another example, if the digital content comprises a video, the viewport may display a frame of the video at a given time point.

At step 320, the first computing device may determine whether any of the plurality of links is displayed in the viewport. The first computing device may determine whether any of the plurality of links is displayed in the viewport via a web browser 210, as may be described in FIG. 2. The web browser 210 may comprise a rendering engine. The rendering engine may interpret the software code (e.g., JavaScript, HTML, or CSS) of the webpage to construct a document object model (DOM) tree. The DOM tree may represent a hierarchical structure of elements (e.g., text, images, or links) in the webpage. The rendering engine may generate a layout and/or visual representation of the elements, including the plurality of links. For example, the rendering engine may calculate the positions and/or dimensions of each of the plurality of links relative to the overall layout of the webpage. The web browser 210 may determine whether one or more of the plurality of links are displayed in the viewport, by comparing the coordinates of the boundary of the viewport with the coordinates of each of the plurality of links. If the web browser 210 determines that the coordinates of a first link, of the plurality of the links, is within the boundary of the viewport, the first computing device may determine (e.g., via the web browser 210) that the first link is displayed in the viewport.

Consistent with the example where the viewport displays the beginning ten percent of an article, the first computing device may determine whether any links are displayed in the beginning ten percent of the article. In the example where the viewport displays a video, the first computing device may determine, while the video is played, whether any links appear alongside each video frame being played.

If the first computing device determines that no link is displayed in the viewport, the method may proceed to step 335, in which the first computing device may wait until another portion of the digital content is displayed. If the first computing device determines one or more links, of the plurality of links, are displayed in the viewport, the method may proceed to step 323, in which the first computing device may determine whether one or more conditions associated with the displayed links are satisfied. The one or more links may comprise a first link. The first link may be directed to a first webpage. For convenience, some steps (e.g., steps 323, 325, and 330) may be described using the example that the first link is displayed in the viewport. It is appreciated that any numbers of links may be displayed in the viewport. If more than one link is displayed in the viewport, the first computing device may process each of the links similarly to processing the first link.

At step 323, the first computing device may determine whether one or more conditions associated with the displayed links (e.g., the first link) are satisfied or not. If the first computing device determines that the one or more conditions associated with the first link are satisfied, the first computing device may collect the first link. The method may proceed to step 325. If the first computing device determines that the one or more conditions associated with the first link are not satisfied, the method may proceed to step 335 to wait until another portion of the digital content is displayed, without collecting the first link.

The one or more conditions may be associated with whether a user of the user device 201 is actively viewing the digital content. Collecting the links associated with a portion of the digital content that the user has actively viewed may be helpful to increase the chance that the collected links are interesting to the user. The user may not be interested in the webpages associated with the portion of the digital content that the user has not viewed.

The one or more conditions may be associated with the location of the link. For example, a condition may be that the first link is displayed in a central area (e.g., the middle one-third) of the viewport. Being displayed in the central area of the viewport may indicate the portion of the digital content that is related to the first link has been read. The central area may be defined based on the reading preference of the user associated with the first computing device, and/or the reading preference of a plurality of other users. The one or more conditions may be associated with the user's interaction with the first link. For example, a condition may be that the first link is displayed in an area where the user's eye gaze is focused. A camera may be connected to the user device to detect the user's eye gaze. The one or more conditions may be associated with a time period during which the first link is displayed in the viewport. For example, one condition may be that the first link is displayed in the viewport for a time period exceeding a threshold. Being displayed in the viewport for a time period exceeding the threshold may indicate the user has viewed and/or is interested in the portion of the digital content where the first link is embedded (e.g., the user did not skip the portion of the digital content). The threshold may be determined based on the size of the viewport and/or the amount of information displayed in the viewport. If the size of the viewport is larger and/or the amount of text displayed in the viewport is larger, the threshold may be higher (e.g., 20 seconds). If the size of the viewport is smaller and/or the amount of text displayed in the viewport is smaller, the threshold may be lower (e.g., 10 seconds).

The one or more conditions may comprise the webpage directed by the first link is associated with a given category. The given category may be preset by the user. For example, if a user is interested in online shopping, the one or more conditions may comprise that the webpage directed by the first link is associated with online shopping. In another example, if the user is interested in verifying the reliability of the information in the digital content, the one or more conditions may comprise the webpage directed by the link to be an information source of the digital content. The one or more conditions may comprise that the first link is selected by the user. For example, the user may right-click the first link to select the first link.

If more than one condition is defined, the first computing device may determine the one or more conditions are satisfied if one, some, or all of the conditions are satisfied. Weights may be assigned to each of the one or more conditions. An overall score may be calculated based on the weights. If the calculated score is higher than (or equal to) a threshold, the first computing device may determine that the one or more conditions are satisfied and may collect the link accordingly. For example, the condition that a link is displayed in a central area of the viewport may be given a weight of 3. The condition that a link is displayed for more than 20 seconds may be given a weight of 2. The condition that a link is directed to an online shopping page may be given a weight of 1. If the first link, which is directed to webpages other than online shopping, is displayed in the central area of the viewport and is displayed for more than 20 seconds, the overall score of the first link may be 3+2=5. If a second link is displayed in a central area for only 10 seconds, but is directed to an online shopping page, the overall score of the second link may be 3+1=4. If the threshold is 4.5, the first computing device may collect the first link but not the second link. It is appreciated that the weights of each condition, and/or the threshold are merely examples. Other weights may be assigned, and/or other thresholds may be determined.

The first computing device may allow the user to manually select the links that the user wishes to collect. If a link is manually selected by a user (e.g., the user clicks the link with a mouse), the first computing device may collect the link based on the user's selection. In another example, a user could right-click a link and manually add (or remove) the link to the list of links to be collected. In the example where weights are used, being selected by the user may be given a weight that is higher than the threshold (e.g., the weight may be 10 if the threshold is 4.5).

At step 325, the first computing device may generate, based on determining that the first link is displayed in the viewport and/or the one or more conditions are satisfied, a preview of the first webpage. The first computing device may receive (e.g., from the content server 205), based on the first link, the first webpage. The first computing device may extract, from the first webpage, information associated with the content of the first webpage. For example, if the first webpage comprises an article, the preview of the first webpage may comprise a title of the article. The preview may comprise a summary of the article. In another example, if the digital content comprises a video, the preview may comprise a trailer of the video or a description of the video. For example, the summary of the article, the trailer of the video, or the description of the video may be generated by an artificial intelligence (AI) model. The preview may be helpful to provide the user with information regarding the linked webpage, to facilitate the user to determine whether to access the linked webpage or to learn the information from the linked webpage without leaving the original webpage. This may increase the efficiency of digital content displaying and/or improve user experience.

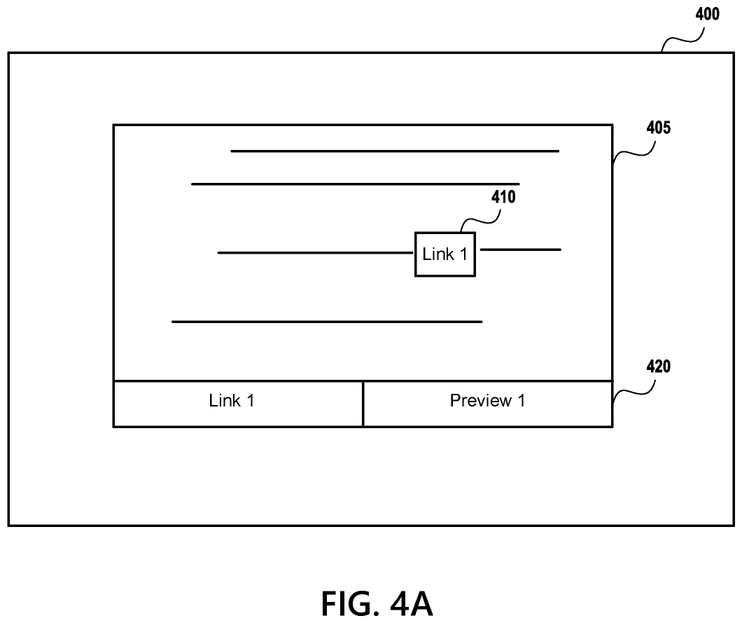

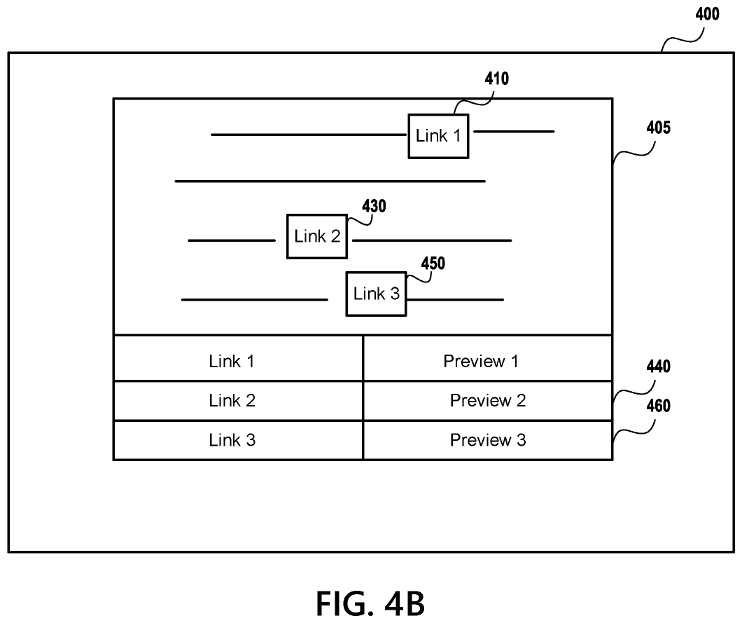

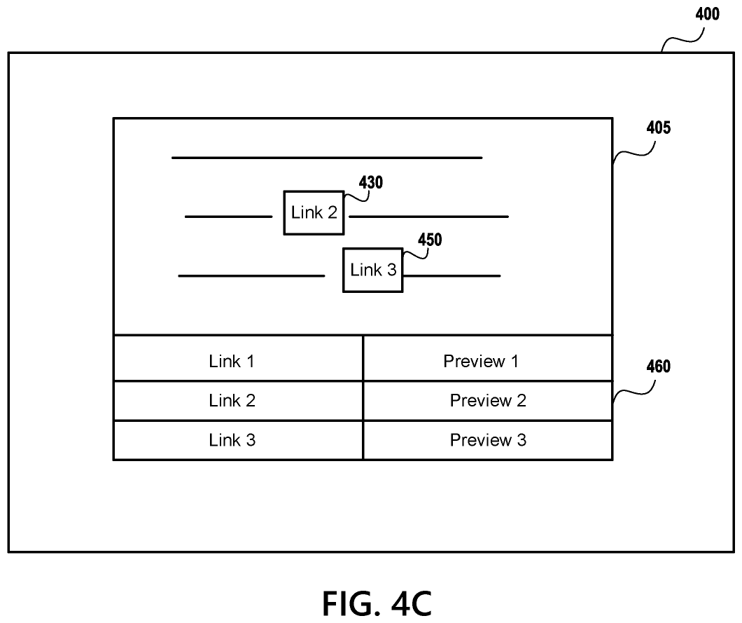

At step 330, the first computing device may cause, in a first area of the user interface, display of the first link and/or the preview of the first webpage. The first area may be located within the viewport, or may be located in a place separate from the viewport. FIG. 4A shows an illustrative user interface 400. The user interface 400 may comprise a viewport 405. A portion of an article may be displayed in the viewport 405. As shown in FIG. 4A, three lines of text are displayed in the viewport 405. Link 1 may be located on the third line 410 in the article. The Link 1 may be displayed in the first area 420. Preview 1 may be a preview of the webpage directed by Link 1. Preview 1 may be displayed in the first area 420. As may be shown in FIGS. 4B to 4C, the article may also comprise Link 2 and Link 3. Link 2 and Link 3 may not be displayed in the viewport at this time, for example, due to the limited size of the user interface. For example, the third line 410 may be at the beginning of the article. Link 2 and/or Link 3 may be located in a middle portion of the article. Link 2 and/or Link 3 may not be displayed in the first area 420 as the user has not viewed Link 2 and/or Link 3 yet. As shown in FIG. 4A, the first area 420 may be located at the bottom of the viewport 405.

It is appreciated that the arrangement in the user interface 400 is merely an example. Each component may be located at a different area in the user interface 400. For example, the viewport 405 may occupy the entire user interface 400. In another example, the first area 420 may be located at another location. For example, the first area 420 may be located at the top of the viewport 405. In another example, the first area 420 may be located at a place separate from the viewport 405 (e.g., in a separate dialog window).

The layout of the links being displayed may be determined based on the size of the viewport of the first computing device, and/or based on the number of links being displayed. For example, each of the links may be displayed in a larger size if the viewport is larger (e.g., if the user interface is larger or if the viewport occupies a larger portion of the user interface) and/or the number of the links is smaller. Each of the links may be displayed in a smaller size if the viewport is smaller (e.g., if the user interface is smaller or the viewport occupies a smaller portion of the user interface) and/or the number of links is larger. For example, the user interface of a laptop may be larger than the user interface of a mobile phone. The collected links may be displayed larger in a user interface associated with a laptop. In another example, the collected links may be displayed larger if the user has just started reading the original digital content and therefore has not viewed too many links yet. The collected links may be displayed smaller as the user views a larger portion of the original digital content and more links have been viewed and/or collected. As described below in greater detail, if too many links have been collected, the display of some of the collected links may be omitted.

Whether to display the preview associated with each link and/or how much detail the preview may be determined based on the size of the viewport and/or based on the number of collected links. For example, the preview may be displayed if the size of the viewport is larger. The preview may be omitted if the size of the viewport is smaller. In another example, the preview may include a title and a summary of the linked webpage, if the size of the viewport is larger. The preview may include the title without the summary of the linked webpage, if the size of the viewport is smaller. The location of the first area 420 may be able to move based on the user's input instructions. For example, the first area 420 may be moved from the bottom of the viewport to the top of the viewport. The size of the first area 420 may be adjusted based on the user's input instructions. For example, if the user wants to view more links, and/or wants to view more detail of the preview associated with each link, the user may adjust the first area 420 into a larger size. If the user is not interested in the links and/or does not want to see the preview, the user may adjust the first area 420 to a smaller size. This may allow the user to customize the display of the collected links and improve user experience towards the user device.

Referring back to FIG. 3, at step 335, the first computing device may determine whether an input instruction to display a second portion, of the digital content, in the viewport is received. If the first computing device determines that no input instruction to display another portion of the digital content is received, for example, until the display of the digital content is ended (e.g., the dialog window of the web browser 210 is closed), the first computing device may end processing the digital content and wait for a new digital content to be requested. If the first computing device determines that an input instruction to display a second portion of the digital content is received, the method may proceed to step 340.

At step 340, the first computing device may determine whether one or more new links (e.g., one or more links other than the first link) are displayed in the viewport after the input instruction to display a second portion of the digital content is received.

For example, the input instruction may comprise a mouse being scrolled in a direction (e.g., downward). The web browser 210 of the first computing device may monitor the changing of the coordinates of the boundary of the viewport as the user scrolls the webpage. The web browser 210 may compare the coordinates of each element (e.g., each link) with the coordinates of the boundary of the viewport, to determine which elements of the webpage are in the viewport. The comparison may be triggered, for example, by an event listening module of the web browser 210. For example, the event listening module may trigger the comparison if an input instruction from the user (e.g., a mouse moving, a clicking, or a touch gesture, etc.) is detected. Consistent with the example in FIG. 4A, FIG. 4B shows the illustrative user interface 400 after receiving the input instruction to display a second portion of the article. For example, the user scrolls two lines down. The web browser 210 may determine the coordinates of the top two lines that were displayed in FIG. 4A are above the coordinates of the upper boundary of the viewport 405. The web browser 210 may determine that the top two lines have already moved out of the boundary of the viewport 405 and no longer be visible within the viewport 405. The web browser 210 may determine that the coordinates of two new lines, lines 430 and 450, which are located below the first portion of the article, are above the lower boundary of the viewport 405 and determine that the two new lines have moved into the viewport 405. Additional links may be located in the second portion of the article. For example, Link 2 and Link 3 may be located in the second portion of the article (e.g., based on the coordinates of Link 2 and Link 3 are within the boundary of the current viewport 405 as shown in FIG. 4B). Link 2 may be located at line 430 in the article. Link 3 may be located at line 450 of the article. If the first computing device determines that no new links are displayed in the viewport, the method may proceed back to step 335 to wait for another input instruction. If the first computing device determines that one or more new links are displayed in the viewport, the method may proceed to step 345 to display the new links.

The first computing device may also determine whether one or more conditions are satisfied for the one or more new links. For example, the one or more conditions may be conditions that are discussed in connection with step 323. For example, the one or more conditions may be associated with the location of the link, the time period during which the link is displayed, the linked webpage is associated with a given category and/or whether the link is manually selected by the user. The method may proceed to step 345 if the one or more conditions are satisfied for at least one new link.

Consistent with the example in FIG. 4B, Link 2, and Link 3 may be new links that are displayed in the viewport 405. The method may proceed to step 345 (e.g., assuming the one or more conditions are satisfied for Link 2 and/or Link 3). At step 345, the first computing device may display some or all of the new links in a second area of the user interface. The first computing device may display some or all of the corresponding previews to the newly linked webpages. Each of the previews may be generated in a way similar to as described in step 325. The first computing device may display some or all of the links that were previously (e.g., before the input instruction is received) displayed in the user interface in the second area. The first computing device may display some or all of the previews associated with the previously displayed links in the second area. As shown in FIG. 4B, the second area 440 may comprise Link 1, Preview 1, Link 2, Preview 2 (e.g., generated based on the webpage directed by Link 2), Link 3, and Preview 3 (e.g., generated based on the webpage directed by Link 3).

The previously displayed links may no longer be displayed in the viewport, but may still be displayed in the area where links and/or previews are displayed. For example, as shown in FIG. 4C, the user may further scroll down the article. A third portion of the article may be displayed in the viewport 405. The third portion may not comprise Link 1. For example, the first computing device may determine the coordinates of Link 1 is outside the boundary of the viewport 405 and determine that Link 1 is no longer displayed in the viewport 405. However, as shown in FIG. 4C, a third area 460 may display Link 1, Preview 1, Link 2, Preview 2, Link 3 and Preview 3. Link 1 and/or Preview 1 may be displayed in the third area 460, for example, based on Link 1 was previously displayed in the viewport 405 and/or Link 1 was previously collected by the first computing device. In this way, by the time the user reaches the end of the original digital content, many links may have been collected and/or displayed in the third area 460. This may be helpful to facilitate the user to find previously displayed links at a later time. For example, Link 1 may be located at the beginning of the digital content. The user may read through the original digital content and want to access the webpage directed to Link 1 the user finishes reading the digital content. Displaying the previously displayed links may help the user to access the linked webpage without the effort of going back to where the link was originally displayed, which may improve the efficiency of the display.

If too many links are displayed in the area (e.g., the third area 460 shown in FIG. 4C), some of the collected links may no longer be displayed. For example, the user may manually select which links no longer need to be displayed. The first computing device may no longer display the selected links. Additionally or alternatively, the collected links may be prioritized. For example, the priority of each collected link may be based on the overall score of the link as described in connection with step 323. For example, the first computing device may display ten (or any other number) collected links that receive the highest scores among the collected links.

If the user accesses a collected link displayed in the third area 460, the user may be able to access the webpage that is directed by the collected link. A go-back button may be displayed with the linked webpage. The go-back button may be embedded with a link that is directed to the original digital content the user reads.

The go-back button may be directed to a dictated portion of the original digital content. For example, the dictated portion may be a portion where the user was reading when the user accesses the linked webpage. This may be helpful to facilitate the user to continue reading from where the user stops. The first computing device may record the portion of the original digital content that the user was reading when the user accesses the linked webpage. For example, the first computing device may record the coordinates of the boundary of the viewport when the user leaves the original digital content. If the user clicks the go-back button after accessing the linked webpage, the first computing device may display the portion of the original digital content the user was reading when the user left. Consistent with the example in FIG. 4C, the user is reading a middle portion of the original digital content. The user may click Link 1 which is displayed in the third area 460. The user may be directed to the first webpage associated with Link 1. If the user clicks a go-back button after viewing the first webpage associated with Link 1, the user may be directed to the portion of the original digital content where the user was reading (e.g., the portion depicted in FIG. 4C).

In another example, the dictated portion may be a portion where the collected link is embedded. Consistent with the example in FIG. 4C, the user is reading a middle portion of the original digital content where Link 1 is not visible. If the user clicks Link 1 which is displayed in the third area 460, the user may be directed to the first webpage associated with Link 1. If the user clicks a go-back button after viewing the first webpage associated with Link 1, the user may be directed to the portion of the original digital content where Link 1 is visible in the main text (e.g., the portion depicted in FIG. 4A).

After the links are displayed, the method may proceed back to step 335. The first computing device may wait for another input instruction to display another portion of the digital content.

The steps of method 300 may be modified, omitted, or performed in other orders, or other steps added as appropriate.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. Accordingly, the scope of the invention should be determined not by the embodiments illustrated, but by the appended claims and their equivalents.

1. A method comprising:
receiving, by a first computing device, a request to display, on a user interface associated with the first computing device, digital content, wherein the digital content comprises a plurality of links each directed to a respective webpage;
receiving, by the first computing device from a second computing device, the digital content;
causing, by the first computing device and on the user interface, display of a first portion, of the digital content, in a viewport of the user interface;
determining, by the first computing device, that a first link, of the plurality of links, is displayed in the viewport, wherein the first link is directed to a first webpage;
generating, by the first computing device and based on determining that the first link is displayed, in the viewport, for a time period exceeding a threshold, a preview of the first webpage; and
causing, by the first computing device in a first area of the user interface, display of the first link and the preview of the first webpage.

2. The method of claim 1, further comprising:
causing, in the viewport and based on an input instruction, display of a second portion of the digital content, wherein the second portion of the digital content comprises a second link, of the plurality of links, that is directed to a second webpage, and wherein the second portion of the digital content does not comprise the first link;
generating a preview of the second webpage; and
causing, in a second area of the user interface, display of:
the first link,
the preview of the first webpage,
the second link, and
the preview of the second webpage.

3. The method of claim 2, wherein the input instruction comprises a mouse being scrolled in a direction.

4. The method of claim 1, wherein the generating the preview of the first link is further based on the first link is displayed in a central area of the user interface.

5. (canceled)

6. The method of claim 1, wherein the generating the preview of the first webpage comprises:
receiving, based on the first link, the first webpage; and
extracting, from the first webpage, information associated with content of the first webpage.

7. The method of claim 1, wherein the first webpage comprises an article, and wherein the preview of the first webpage comprises at least one of:
a title of the article; or
a summary of the article.

8. A system comprising:
a first computing device; and
a second computing device;
wherein the first computing device is configured to:
receive a request to display, on a user interface associated with the first computing device, digital content, wherein the digital content comprises a plurality of links each directed to a respective webpage;
receive, from a second computing device, the digital content;
cause, on the user interface, display of a first portion, of the digital content, in a viewport of the user interface;
determine that a first link, of the plurality of links, is displayed in the viewport, wherein the first link is directed to a first webpage;
generate, based on determining that the first link is displayed, in the viewport, for a time period exceeding a threshold, a preview of the first webpage; and
cause, in a first area of the user interface, display of the first link and the preview of the first webpage; and
wherein the second computing device is configured to:
send, to the first computing device, the digital content.

9. The system of claim 8, wherein the first computing device is further configured to:
cause, in the viewport and based on an input instruction, a second portion of the digital content, wherein the second portion of the digital content comprises a second link, of the plurality of links, that is directed to a second webpage, and wherein the second portion of the digital content does not comprise the first link;
generate a preview of the second webpage; and
cause, in a second area of the user interface, display of:
the first link,
the preview of the first webpage,
the second link, and
the preview of the second webpage.

10. The system of claim 9, wherein the input instruction comprises a mouse being scrolled in a direction.

11. The system of claim 8, wherein the first computing device is further configured to generate the preview of the first link based on the first link is displayed in a central area of the user interface.

12. (canceled)

13. The system of claim 8, wherein the first computing device is configured to generate the preview of the first webpage by performance of actions comprising:
receiving, based on the first link, the first webpage; and
extracting, from the first webpage, information associated with content of the first webpage.

14. The system of claim 8, wherein the first webpage comprises an article, and wherein the preview of the first webpage comprises at least one of:
a title of the article; or
a summary of the article.

15. A non-transitory computer-readable medium storing computer instructions that, when executed by one or more processors, cause performance of actions comprising:
receiving a request to display, on a user interface associated with a first computing device, digital content, wherein the digital content comprises a plurality of links each directed to a respective webpage;
receiving, from a second computing device, the digital content;
causing, on the user interface, display of a first portion, of the digital content, in a viewport of the user interface;
determining that a first link, of the plurality of links, is displayed in the viewport, wherein the first link is directed to a first webpage;
generating, based on determining that the first link is displayed, in the viewport, for a time period exceeding a threshold, a preview of the first webpage; and
causing, in a first area of the user interface, display of the first link and the preview of the first webpage;
causing, in the viewport and based on an input instruction, display of a second portion of the digital content, wherein the second portion of the digital content comprises a second link, of the plurality of links, that is directed to a second webpage, and wherein the second portion of the digital content does not comprise the first link;
generating a preview of the second webpage; and
causing, in a second area of the user interface, display of:
the first link,
the preview of the first webpage,
the second link, and
the preview of the second webpage.

16. The non-transitory computer-readable medium of claim 15, wherein the input instruction comprises a mouse being scrolled in a direction.

17. The non-transitory computer-readable medium of claim 15, wherein the instructions, when executed by the one or more processors, cause generating the preview of the first webpage by causing performance of actions comprising:
receiving, based on the first link, the first webpage; and
extracting, from the first webpage, information associated with content of the first webpage.

18. The non-transitory computer-readable medium of claim 15, wherein the instructions, when executed by the one or more processors, further cause the one or more processors to generate the preview of the first link further based on the first link is displayed in a central area of the user interface.

19. (canceled)

20. The non-transitory computer-readable medium of claim 15, wherein the first webpage comprises an article, and wherein the preview of the first webpage comprises at least one of:
a title of the article; or
a summary of the article.
